(19) United States
(12) Patent Application Publication
(10) Pub. No.: US 2001/0047834 A1
(43) Pub. Date: Dec. 6, 2001

(54) Assembly with a gate valve and device for the circulation and distribution of fluid comprising such as assembly

(76) Inventors: Denis Menin, Houssen (FR); David Guyon, Orbey (FR)

Correspondence Address: YOUNG & THOMPSON, 745 SOUTH 23RD STREET 2ND FLOOR, ARLINGTON, VA, 22202

(21) Appl. No.: 09/512,676

(22) Filed: Feb. 25, 2000

(30) Foreign Application Priority Data
Feb. 26, 1999 (FR) 99 02531

(51) Int. Cl. F16K 11/052

(52) U.S. Cl. 137/875; 137/625.46

(57) ABSTRACT

The present invention has for its object an assembly with a gate valve or distribution or a closure valve, as well as a device for the circulation and distribution of fluid comprising such an assembly.

Gate valve assembly adapted to control the passage of at least one stream of fluid (1) between at least one upstream or primary conduit and at least one downstream or secondary conduit, and comprising a movable gate valve body forming a distribution and/or closure member, characterized in that the gate valve body (4) forms, in at least one of its end positions, a portion of the wall of the intermediate conduit portion or portions (5, 5′) connecting said at least one upstream or primary conduit (2) to said at least one downstream or secondary conduit (3, 3′).

The present invention relates to the field of directing circulation of fluids through networks and circuits formed by conduits, tubular or not, interconnected with each other, and has for its object an assembly of a gate valve for distribution and/or closure valve, as well as a circulation and distribution device for fluid(s) comprising such a gate valve assembly.

In systems for the circulation and distribution of liquid or gaseous fluids, it is usual to use, as members for closing or configuring circulation circuits, gate valves, particularly in motor vehicles.

However, in construction, the structure and the installation of existing gate valves are such that they substantially disturb the flow of fluids, no matter what their positioning, and accordingly generate systematically a substantial pressure drop, even in the open position permitting the free passage of the stream of fluid.

These disturbances are moreover often further increased when the actuation of the gate valve is effected by a control device mounted in the circulation system or directly on the gate valve.

Furthermore, existing gate valves and their control devices have complicated constructions, requiring careful operations of mounting and assembly and are directly and frontally exposed to the pressure of the flow of fluid, which generates substantial pressures on the body of the gate valve and accelerates their wear and the loss of sealing that can be attained.

The present invention has for its particular object to overcome at least certain ones of the mentioned drawbacks.

To this end, it has for its object an assembly with a gate valve or distribution or closure valve, adapted to control the passage of at least one fluid stream between at least one upstream or primary conduit and at least one downstream or secondary conduit, and comprising a movable gate valve body forming a distribution and/or closure member, characterized in that the gate valve body has, in at least one of its end positions, a portion of the wall of the intermediate conduit portion or portions connecting said at least one upstream or primary conduit to said at least one downstream or secondary conduit.

The invention will be better understood from the following description, which relates to preferred embodiments, given by way of non-limiting examples, and explained with reference to the accompanying schematic drawings, in which:

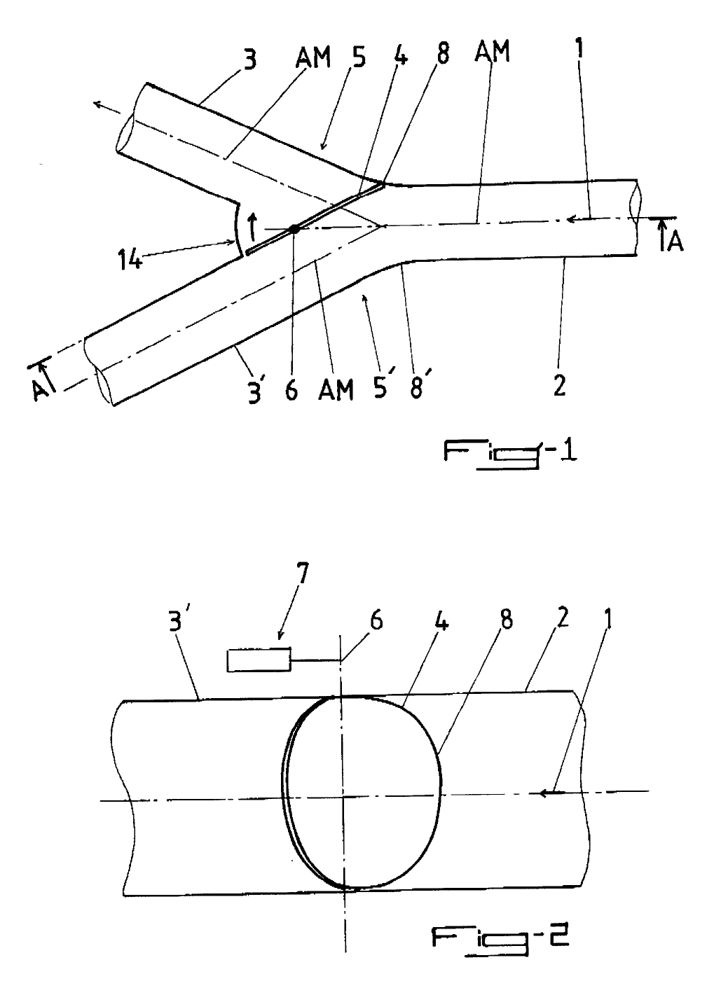

FIG. 1 is a schematic plan view of a gate valve assembly according to a first embodiment of the invention

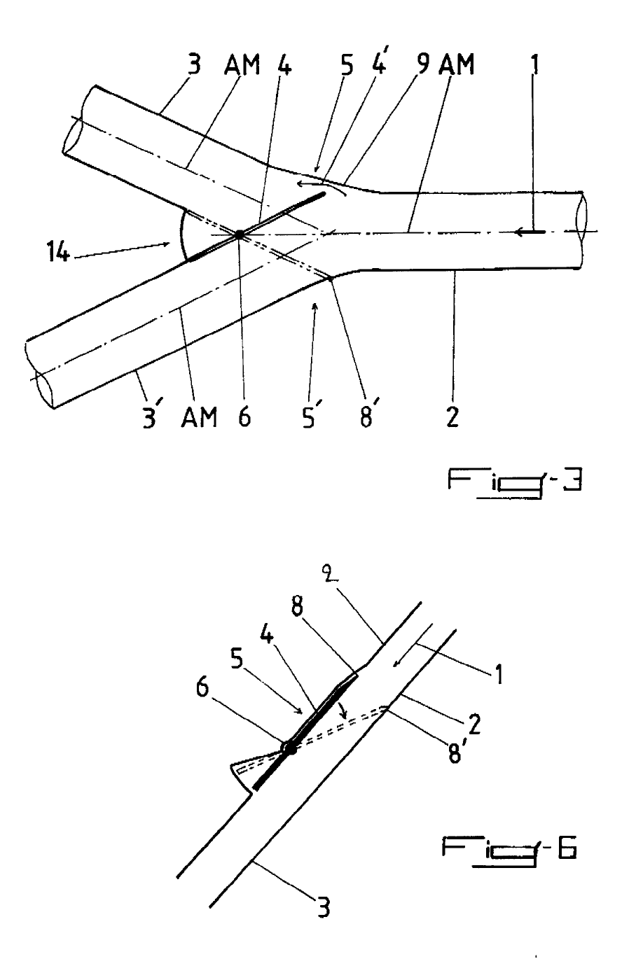

FIG. 2 is a side elevational view in cross-section on the line A-A of FIG. 1 and on a different scale, of the valve assembly shown in FIG. 1;

FIG. 3 is a view similar to that of FIG. 1 of a modified embodiment of the gate valve assembly shown in the latter;

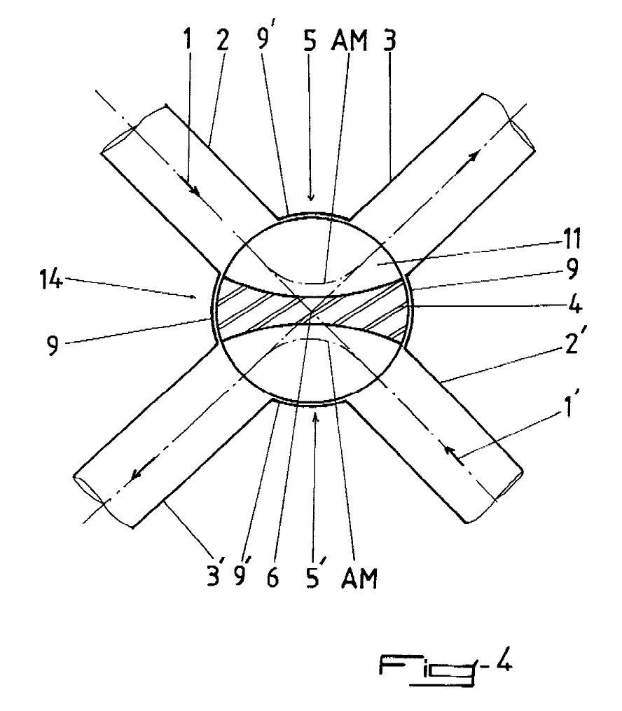

FIG. 4 is a schematic plan view of a gate valve assembly according to a second embodiment of the invention;

FIG. 5 is a view similar to that of FIG. 4 of a modified embodiment of the gate valve assembly shown in this latter;

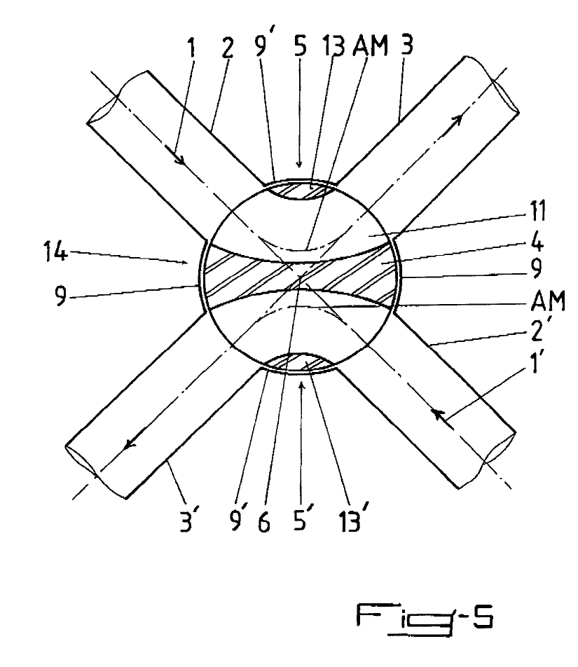

FIG. 6 is a view similar to that of FIG. 1, of a gate valve assembly according to a third embodiment of the invention;

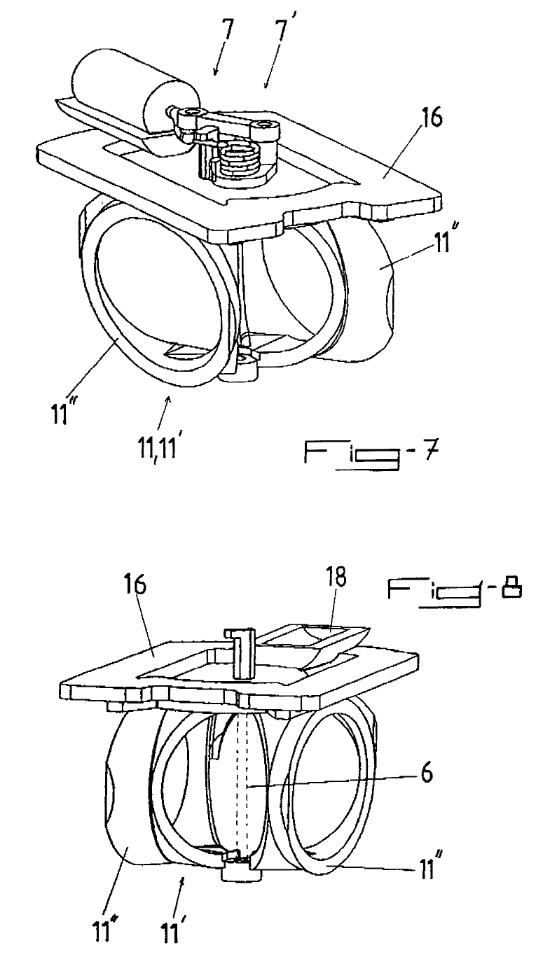

FIG. 7 is a perspective view of a piece to be inserted, integrating and carrying different components of a gate valve assembly of the type shown in FIGS. 1 to 3;

FIG. 8 is a perspective view of a piece shown in FIG. 6 but without its functional components;

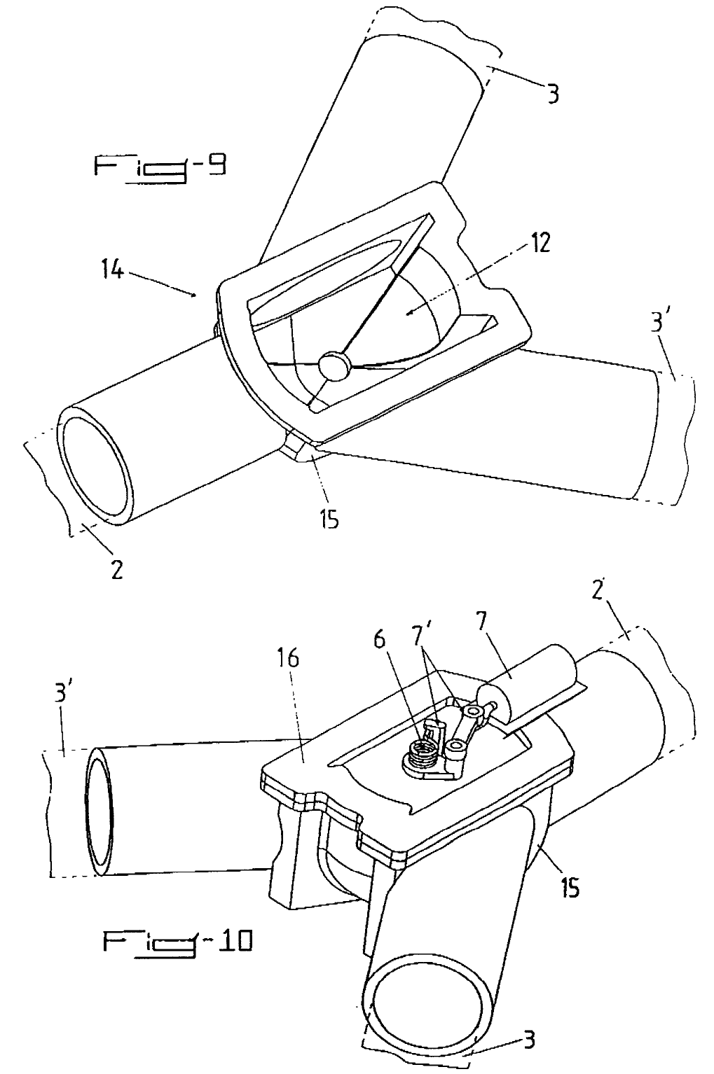

FIG. 9 is a perspective view of the single piece forming a portion of the transfer and distribution device according to the invention;

FIG. 10 is a plan view in perspective of the transfer and distribution device obtained by mounting the piece to be inserted of FIG. 7, into a single piece of FIG. 9, and

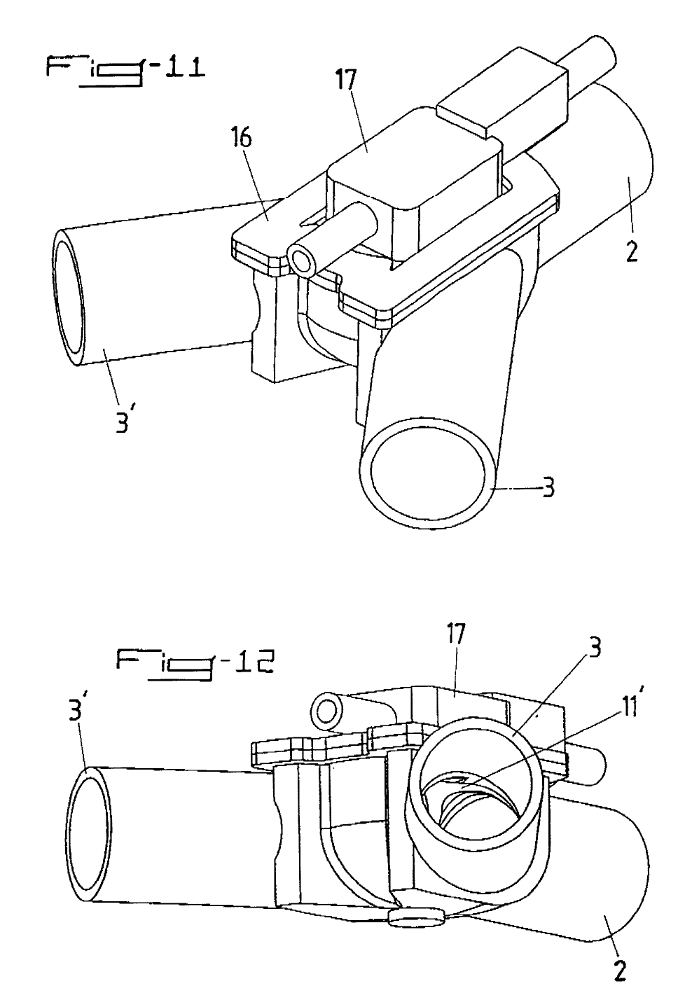

FIGS. 11 and 12 are perspective views, but from different angles, of a device according to claim 10, after emplacement of the shunt and measurement probe.

As shown particularly in FIGS. 1 to 6 of the accompanying drawings, the gate valve or distribution or closure valve assembly is adapted to control the passage of at least one stream of fluid 1, 1′ between at least one upstream or primary conduit 2, 2′ and at least one downstream or secondary conduit 3, 3′ and comprises a movable gate valve body 4 forming a distribution and/or closure member.

According to the invention, the gate valve body 4 comprises, in at least one of its end positions, a portion of the wall of the intermediate conduit portion or portions 5, 5′ connecting said at least one upstream or primary conduit 2, 2′ to said at least one downstream or secondary conduit 3, 3′.

According to a first characteristic of the invention, the axle of rotation 6 carrying the gate valve body 4 is mounted by being displaced laterally relative to the median axis or axes AM of the possible paths of circulation for the flow of the fluid 1, 1′, particularly in the downstream or secondary conduits 3, 3′.

Preferably, the gate valve body 4 forms a portion of the intermediate conduit portion or portions 5, 5′ in each of its end positions, which permits reducing the pressure drop of the stream of fluid in the two positions normally occupied by the gate valve body 4.

As shown in FIGS. 1 and 3 to 6 of the accompanying drawings, a surface of the gate valve body 4 exposed to the stream of fluid 1, 1′ is, no matter what the end position taken by said gate valve body, struck by said stream at an acute angle (as shown by the angle between the surface in question of said gate valve body 4 and the median axis AM of the path of the fluid 1, 1′ in the corresponding upstream conduit 2, 2′). As a result, there is a low pressure on said gate valve body 4, this latter performing more of a deviation of the stream of fluid 1, 1′, than an obstruction to the passage to be prevented.

According to another characteristic of the invention shown particularly in FIGS. 7 and 10 to 12 of the accompanying drawings, and so as further to reduce the turbulence that may be generated in the path permitted by the presence of the example of closure and/or distribution, the control device 7 of the gate valve is located outside the stream of fluid 1, 1′ in the primary conduits 2, 2 and secondary conduits 3, 3′, the positioning of said gate valve body 4 being determined, as the case may be, as a function of at least one physical-chemical parameter of the fluid or fluids 1, 1′, such as for example the temperature, measured in a secondary shunt or circulation circuit 17, supplied by the primary conduit 2, 2′ or secondary conduit 3, 3′ or connecting two of these latter.

The control device 7 ensuring the guidance of the gate valve assembly or distribution and/or closure valve, can thus comprise a thermostat controlled thermally by a fluid stream present in a secondary circuit, separated from the circuit constituted by the primary conduits 2, 2′ and secondary conduits 3, 3′ or disposed in a branch relative to this latter.

The guidance of the gate valve assembly or of the valve can, as a modification, also be effected by a control thermostat, for example an electric heater, controlled by the user, in a wax cartridge, permitting the expansion of this latter and the recovery of the resulting movement for actuating the gate valve body 4 by means of the axle of rotation 6 (see particularly FIGS. 7 and 10 of the accompanying drawings).

It is also possible to combine the two preceding guidance modes, by controlled electrical heating and by the thermal action of a fluid stream circulating in a secondary circuit, which permits guaranteeing the thermostatic operation even in the case of misfunction of the electrical control.

Finally, the guidance of the gate valve assembly or of the valve can also be effected by controlled mechanical actuation or by an electric motor, such as a couple motor, a DC motor or else a stepping motor.

As to the type of control of the assembly with a gate valve or a valve, there can be provided either operation with only two conditions (all or nothing), corresponding to swinging of the gate valve body 4 into one of its two end positions, or an operation of the continuous type proportional to the control.

In the latter case, it is possible to separate the fluid flow 1, 1′ from the primary conduit 2, 2′ into two secondary streams each flowing in a corresponding secondary conduit 3, 3′. The variation of the position of the gate valve body 4 is thus controlled by the control device 7 as a function of the value of the measured parameter, for example the temperature of the fluid 1, 1′.

According to another characteristic of the invention, shown particularly in FIGS. 3 and 4 of the accompanying drawings, the gate valve body 4 and at least a portion of the regions 8, 8′ for bearing on this latter at the level of the internal wall of the intermediate conduit portion or portions 5, 5′ or at least a portion of the regions 9, 9′ of the internal wall of the intermediate conduit portion or portions 5, 5′ adapted to coact supplementally to the shapes of the gate valve body 4 to carry out a closure, in at least one of the end positions of this latter, can have respective shapes such that they permit inside at least one end position, a calibrated loss of fluid 1, 1′ to the secondary conduit 3, 3′ against which the passage is closed.

This calibrated loss is obtained by defining a predetermined passage opening 4′ between the edge of the gate valve body 4 and said bearing region or region of complementary shape of the internal wall of the portions of the intermediate conduits 5, 5′. This opening can be formed by providing a deformation at the level of the corresponding zone or zones of said internal wall and/or by altering a portion at least of the external edge of the gate valve body 4.

As a modification, the calibrated loss can also be obtained by providing one or several openings of predetermined shape and dimension in the gate valve body 4 itself, which permits particularly obtaining identical greater losses in the two end positions of said gate valve body 4.

The practical embodiment of the calibrated loss should, as much as possible, not give rise to turbulence in the flow of the fluid 1, 1′ along the permitted path.

To obtain economical industrial production, which will be reliable and less difficult, particularly in terms of sealing, it can preferably be provided that the gate valve body 4 and the rotation axle 6 be made in the form of an element or body 11 to be inserted and be, as the case may be, integrated into a piece 11′ to be inserted (also called a cassette) also forming the internal walls of the intermediate conduit portion or portions 5, 5′, in particular the bearing zones 8, 8′ of the valve body 4 in its end positions or the internal wall zones 9, 9′ of similar shape, said element or piece 11 to be inserted being mounted to be surrounded in a cutout or recess 12 of corresponding shape provided in a connection region of said at least one primary conduit 2, 2′ with said at least one secondary conduit 3, 3′ (see FIGS. 4 to 9).

The introduction of the element or body 11 to be inserted, or of the piece 11′ to be inserted, preferably takes places in a direction parallel to the final direction of the axle 6 of rotation after its mounting.

FIGS. 1 to 6 of the accompanying drawings show schematically, by way of non-limiting examples, three cases of practical use of the invention, corresponding in fact to three embodiments of this latter, namely, on the one hand, use as a closure member in a system with two paths (an inlet path and an outlet path), shown in FIG. 6 of the accompanying drawings, on the other hand, the use of a distribution/closure member in a system of three paths (an inlet path and two outlet paths), shown in FIGS. 1 to 3 and 7 to 12 of the accompanying drawings, and, finally, the use as a distribution member in a system with four paths (two inlet paths and two outlet paths), shown in FIGS. 4 and 5 of the accompanying drawings.

In these three embodiments, the gate valve body 4 constitutes with the body 11″ of the piece 11′ to be inserted or the walls of the intermediate conduit portions 5, 5′, a closure and/or a distribution valve integrated into the region of convergence of the primary conduits 2, 2′ and secondary conduits 3, 3′.

In the embodiment of FIG. 6, the gate valve assembly performs only one function of the opening/closing type, for the passage between an upstream conduit portion 2 and a downstream conduit portion 3. Thus, in its retracted position, the gate valve body 4 lets the fluid 1 pass freely with minimum pressure drop and, in its extended position, said gate valve body 4 closes the passage and prevents any circulation of fluid 1.

In the embodiment of FIGS. 1 to 3 and 7 to 12, the gate valve assembly permits directing the stream of fluid 1 flowing in the primary conduit 2 toward one of the two secondary conduits 3 or 3′, by totalling closing (or with calibrated leakage) the inlet toward the other of said secondary conduits 3 or 3′, whilst giving rise to minimum pressure drop.

As shown in FIGS. 1 to 3 and 6 of the accompanying drawings, the portion of the gate valve body 4 extending in an upstream direction from the axle 6 of rotation can preferably be greater than the portion of the gate valve body 4 extending in the downstream direction, preferably with a ratio of about 2:1, said gate valve body 4 being preferably, in particular in a system with three paths of Y shape, aligned with the median axis AM of the fluid stream 1, 1′ in the primary conduit 2, 2′ in the intermediate open position.

In the embodiment of FIGS. 4 and 5 of the accompanying drawings, suitable for a system with four paths, the gate valve body 4 can preferably be present in the form of a separation wall delimiting, as the case may be in coaction with two opposite wall portions 9, 9′ or 13, 13′ located on opposite sides of said gate valve body 4, two portions of paths or intermediate conduits 5 and 5′ each connecting an upstream conduit 2, 2′ and a downstream conduit 3, 3′ together, the rotation of said gate valve body 4 from one end position to the other permitting reversing the connections between the upstream conduits 2, 2′ and downstream conduits 3, 3′.

So as to facilitate the mounting of the gate valve assembly and to minimize pressure drop in the fluids 1 and 1′ in this embodiment, the gate valve body 4 and the two opposite wall portions 13, 13′ preferably form an integral part of a body 11 mounted rotatably, in the manner of a spherical, conical or cylindrical plug, at the level of the region of the convergence node 14 of the upstream conduits 2, 2′ and downstream conduits 3, 3′, the gate valve body 4 forming in transverse cross-section a double convex wall and wall portions 13, 13′ having a convex configuration directed toward the respective opposite convex reinforcements of said gate valve body 4.

As shown in FIGS. 4 and 5, the gate valve body 4 is eccentric relative to the possible path for the streams of fluid 1 and 1′ and serves as a separation wall for the two circuits and the lateral wall elements for each of the intermediate conduit portions 5 and 5′. By a simple rotation through 90°, it is possible to carry out simultaneously two reversals of connection, by permitting to pass from a circulation arrangement 1-3/1′-3′ to a circulation arrangement 1-3′/1′-3.

The assembly of the gate valve or valve is preferably constituted by components of thermoplastic material (except the control members) assembled together by welding, screwing or cementing. It is particularly possible to make the gate valve body 4 of a single piece with the rotation axle 6. As a modification, the movable and functional components can also be constituted by metallic members, welded or screwed together.

The present invention also has for its object a device for the circulation and distribution of fluid 1, 1′ between at least one primary conduit 2, 2′ and at least one secondary conduit 3, 3′.

This circulation and distribution device is principally constituted, on the one hand, by a single piece member 15, formed by the convergent and communicating assembly of several tubular conduits 2, 2′, 3, 3′ or several portions of tubular conduits connected to the conduits 2, 2′, 3, 3′, particularly of a Y shape (system with three paths) or of X shape (system with four paths), and having a cutout of access opening 12 at the level of the region of the convergence node 14 of the primary conduits 2, 2′ and secondary conduits 3, 3′ and, on the other hand, by an assembly with a gate valve or valve such as described above, whose gate valve body 4 or analogous closure and/or distribution member, and the rotation axle 6, are at least emplaced in said region of the convergence node 14 through the access opening 12, this latter being closed in a sealed manner by a corresponding cover or plug 16.

According to a supplemental characteristic of the invention, shown particularly in FIGS. 7, 8 and 10 of the accompanying drawings, the rotation axle 6 passes through the cover or closure plug 16 of the access opening 12, this latter carrying at least a portion of the actuating mechanism 7′ forming a component of the control device 7 for the gate valve.

As seen more precisely in FIG. 8 of the accompanying drawings, the closure cover 16 could if desired be made integral with the structural body 11″ of the piece 11′ to be inserted and with at least one support element 18 for at least a portion of the guide device 7. The seal could then be made by surface contact between the peripheral edge regions of the opening 12 and of the cover 16 forming a support platform (FIGS. 9 and 10).

For the case in which the gate valve assembly comprises a piece 11′ to be inserted, the sealing to fluids 1, 1′ at the level of the convergence region could be easily optimized by the provision of a preliminary assembly of the structural body 11′/gate valve body 4 and axle 6 of rotation, whose peripheral contacts of the components in the end positions could be finely adjusted and would not be affected by the mounting of said piece 11′ to be inserted in said piece 15.

The assembly with the gate valve and the circulation and distribution device described above are particularly well adapted for use in the cooling circuit of an automobile vehicle with a heat engine, but also for applications in circuits for the circulation of air, of fuel, of windshield cleaning liquid and the exhaust gas of such vehicles.

Moreover, it can also be envisaged to use the objects of the present invention in the framework of cooling circuits for heat engines in general, in the framework of motors or electrical generators or else in the field of sanitation and, more broadly speaking, in all the technical fields using a circulation of liquid or gaseous fluids.

Of course, the invention is not limited to the embodiments that have been described and shown in the accompanying drawings. Modifications remain possible, particularly as to the construction of the various elements or by substitution of technical equivalents, without thereby departing from the scope of protection of the invention.

1. Gate valve assembly or distribution or closure valve adapted to control the passage of at least one stream of fluid between at least one upstream or primary conduit and at least one downstream or secondary conduit and comprising a movable gate valve body forming a distribution and/or closure member, characterized in that the gate valve body (4) forms, in at least one of its end positions, a portion of the wall of the intermediate conduit portion or portions (5, 5′) connecting said at least one upstream or primary conduit (2, 2′) to said at least one downstream or secondary conduit (3, 3′).

2. Gate valve assembly according to claim 1, characterized in that the rotation axle (6) carrying the gate valve body (4) is mounted by being displaced laterally relative to the median axis or axes (AM) for the possible path or paths of circulation for the stream or streams of fluid (1, 1′) particularly in the downstream or secondary conduits (3, 3′), the gate valve body (4) forming a portion of the intermediate conduit portion or portions (5, 5′) in each of its end positions.

3. Gate valve assembly according to any one of claims 1 and 2, characterized in that the control device (7) for the gate valve is located outside the fluid stream or streams (1, 1′) in the primary conduit or conduits (2, 2′) and secondary conduit or conduits (3, 3′), the position of said gate valve body 4 being determined, as the case may be, as a function of at least one physical-chemical parameter of the fluid or fluids (1, 1′) such as for example temperature, measured in a derivation or secondary circulation circuit, supplied by a primary conduit (2, 2′) or secondary conduit (3, 3′) or interconnecting two of these latter.

4. Gate valve assembly according to any one of claims 1 to 3, characterized in that the gate valve (4) and at least a portion of the bearing zone or zones (8, 8′) of this latter at the level of the internal wall of the intermediate conduit portion or portions (5, 5′), or at least a portion of the zone or zones (9, 9′) of the internal wall of the intermediate conduit portion or portions (5, 5′) adapted to coact shape-matingly with said gate valve body (4) to effect a closure, in at least one of the end positions of this latter, having respective shapes such that they permit in said at least end position a calibrated leakage of fluid (1, 1′) toward the secondary conduit (3, 3′) toward which the passage is closed.

5. Gate valve assembly according to any one of claims 1 to 3, characterized in that the gate valve body (4) comprises one or several openings of predetermined size and shape.

6. Gate valve assembly according to any one of claims 2 to 5, characterized in that the gate valve body (4) and the rotation axle (6) are in the form of an element or body (11) to be inserted and are, as the case may be, integrated into a member (11′) to be inserted also forming the internal walls of the intermediate conduit portion or portions (5, 5′), and particularly the bearing regions (8, 8′) of the body of the gate valve (4) in its end positions or regions of internal walls (9, 9′) of complementary shape, said element (11) or piece to be inserted being mounted by being received in a cutout or a cavity (12) of corresponding shape provided in a connection region for said at least one primary conduit (2, 2′) with said at least one secondary conduit (3, 3′).

7. Gate valve assembly according to any one of claims 1 to 6, characterized in that the portion of the gate valve body (4) extending in an upstream direction from the rotation axle (6) is greater than the portion of the gate valve body (4) extending in a downstream direction, preferably with a ratio of about 2:1, said gate valve body (4) being aligned with the median axis (AM) of the stream of fluid (1, 1′) in the primary conduit (2, 2′) in an intermediate open position.

8. Gate valve assembly according to any one of claims 1 to 6, characterized in that the gate valve body (4) is present in the form of a separation wall delimiting, as the case may be in coaction with two opposite wall portions (9, 9′ or 13, 13′) located on opposite sides of said gate valve body (4), two portions of paths or of intermediate conduits (5 and 5′) each connecting an upstream conduit (2, 2′) and a downstream conduit (3, 3′) together, the rotation of said gate valve body (4) from one end position to the other permitting reversing the connections between the upstream conduits (2, 2′) and downstream conduits (3, 3′).

9. Gate valve assembly according to claim 8, characterized in that the gate valve body (4) and the two opposite wall portions (13, 13′) form an integral part of a body (11) mounted for rotation in the manner of a spherical, conical or cylindrical plug, at the level of the region of the convergence hub (14) of the upstream conduits (2, 2′) and downstream conduits (3, 3′), the gate valve body (4) forming in transverse cross-section a double convex wall and the portions of the walls (13, 13′) having a curved configuration directed toward opposed convex reinforcements respectively of said gate valve body (4).

10. Device for circulation and distribution of fluid between at least one primary conduit and at least one secondary conduit, characterized in that it is principally constituted, on the one hand, by a single piece (15) forming the convergent assembly and communicating with several tubular conduits (2, 2′, 3, 3′) or several portions of tubular conduits connected to conduits (2, 2′, 3, 3′), particularly of Y shape or X shape, and having a cutout of an access opening (12) at the level of the region of the convergence (14) of the primary conduit or conduits (2, 2′) and secondary conduit or conduits (3, 3′), and, on the other hand, by a gate valve assembly or a valve according to any one of claims 1 to 9, whose gate valve body (4) or closure and/or analogous distribution member and the rotation axle (6) are at least emplaced in said convergence node region (14) through the access opening (12), this latter being closed in a sealed manner by a corresponding cover or plug (16).

11. Device according to claim 10, characterized in that the rotation axle (6) passes through the cover or closure plug (16) for the access opening (12), this latter carrying at least a portion of the actuating mechanism (7′) forming a component of the control device (7) of the gate valve.
